(19) United States
(12) Patent Application Publication
(10) Pub. No.: US 2008/0212537 A1
(43) Pub. Date: Sep. 4, 2008

(54) Data Packet Handover Control

(76) Inventor: Dror Bukai, Sunnyvale, CA (US)

Correspondence Address: Connolly Bove Lodge & Hutz LLP, Suite 800, 1990 M Street, N.W., Washington, DC, 20036, US

(21) Appl. No.: 11/538,092

(22) Filed: Oct. 3, 2006

Related U.S. Application Data
(60) Provisional application No. 60/724,161, filed on Oct. 6, 2005.

(51) Int. Cl. H04Q 7/20

(52) U.S. Cl. 370/332

(57) ABSTRACT

A method of and apparatus for packet data streaming handover between disparate wireless and wired end-user agents may address changes in circumstances surrounding packet communications between end-user agents connected over various communications networks. The end-user agents may be coupled to at least one handover controller. One or more handover controllers may be used to implement handovers, which may be based on quality signals received from end-user agents.

### FIELD OF THE INVENTION

Embodiments of the invention relate, in general, to the field of media over packet data (MoPD) communications, and more particularly to a system and method for handover execution in a MoPD environment.

### BACKGROUND OF THE INVENTION

The field of media over packet data (MoPD) communications, for example, but not limited to, media over Internet Protocol (MoIP) (e.g., voice over Internet Protocol (VoIP)), has become increasingly important in today's society. We live in an era of multiple communication networks that interact with each other. Wireless networks and wire-line networks surround us at home, in the office and while traveling. Consumer and business telecommunication needs vary based on presence at home, at work, and in motion. By way of example, landline operators have served wire-based access market demand for voice services at home and at work, while cellular providers have provided services to mobile users. Improvements in wireless technologies, satisfactory quality of service, the convenience of anywhere-anytime availability and mass-market adoption of cellular services have created economic conditions for migration from landline toward cellular communications. One problem is that a plurality of disparate communication networks increase hassle and decrease business efficiency.

One area associated with MoPD communications relates to a handoff or handover process. MoPD handover is directed to the problem of multiple disparate systems by way of integration through a handover between the disparate networks. A problem is to accomplish this without application layer and service interruption or user intervention. Such seamless handover would serve to increase business efficiency by means of anytime, anywhere and through any device communication and improved end-user availability.

### SUMMARY OF THE INVENTION

From the foregoing, it may be appreciated by those skilled in the art that a need has arisen for improved handover capabilities for media over packet data (MoPD) communication. In accordance with one embodiment of the present invention, a system and method for handover execution in a MoPD environment are provided, which substantially eliminates or reduces disadvantages and problems of conventional handover techniques.

According to one embodiment of the present invention, a method for handover execution in a MoPD environment may comprise communicating, by end-user agents attached to a packet data network, quality signals to handover controllers, where a handover controller may analyze the received quality signals and decide to handover data packets from one end-user agent (terminated end-user agent) to another end-user agent (target end-user agent). A handover controller may further initiate a handover process for notifying the target end-user agent of handover process by means of session initiation command, receiving session initiation signal from the target end-user agent, notifying the terminated end-user agent of the handover by means of session termination signal, creating a data path between the end-user agent and the target end-user agent, and terminating a data path between the end-user agent and the terminated end-user agent. A packet data path may be routed through a handover controller for packet data processing such as decryption and encryption, aggregation and re-encapsulation. A handover session initiation command may be received by the end-user agent, and the end-user agent may then respond to the handover command message by transmitting a session acknowledge message to a handover controller. The data path initiation command may be received by the target end-user agent, and the end-user agent may then respond to the handover command message by transmitting a data path acknowledge message to a handover controller and simply receiving and transmitting data packets through a data port that is physically connected to the data network. The data path termination command may be received by the terminated end-user agent, and the end-user agent may respond to the handover command message by terminating a pre-existing data path and simply stopping reception and transmission of data packets through a data port that is physically connected to the data network.

Certain embodiments of the present invention may provide a number of technical advantages. For example, according to one embodiment of the present invention, a handover execution is provided that may include handover between end-devices, such as a cellular phone and an office voice over packet data phone, that would otherwise be completely disintegrated or that it would otherwise take a significant effort in time and computation resources to seamlessly integrate and handover traffic between one and the other. The handover execution approach disclosed may operate to transpose quality signaling from an application layer to a MoPD physical layer, which may allow MoPD stations to respond to handover conditions and commands more quickly and to a handover controller to remove and establish data path without losing any noticeable application data. This, in turn, may result in increased handover quality, minimal interruption time during a handover, reduced probability of dropping connections across handovers, and/or minimal handover latency. By implementing a MoPD handover controller, other delays in making an effective handover may be minimized or otherwise avoided, thereby increasing the overall quality of communications in a MoPD environment.

The embodiments, which follow, may enjoy some, all, or none of these advantages. Other technical advantages may be readily apparent to one skilled in the art from the following figures, the description, and the claims.

### BRIEF DESCRIPTION OF THE DRAWINGS

To provide a more complete understanding of the present invention and features and advantages thereof, reference is made to the following description, taken in conjunction with the accompanying figures, wherein like reference numerals represent like parts, in which:

FIG. 1 is a block diagram of a data packet handover controller attached to a plurality of communication networks and end-user agents through a packet data network in accordance with one embodiment of the present invention; and

FIG. 2 is a chain of events control diagram presenting the handover process from initiation to completion according to an embodiment of the invention by way of example.

### DETAILED DESCRIPTION OF EMBODIMENTS OF THE INVENTION

A handover process generally refers to a scenario in which an end-user crosses the boundaries between one network, such as a land-line network, and another network, such as a wireless network. Unlike the traditional wireless handover process that happens when a user passes from one cell to another cell within the wireless network, the handover process being addressed here occurs between end-user agents even if they are not members of the same network, but rather connected through disparate networks through a packet data network to a handover controller. In general, the problem is that of handing over data packets between end-user agents that may be attached to a handover controller through a packet data network that may be connected to a plurality of other networks.

Furthermore, a handover in a single network may generally be a response to geographic movement by a mobile station from one cell to another. However, in the generalized case being considered here, the handover may be a response to a need to migrate from one end-user agent, such as a mobile device, to another end-user agent, such as a desktop computer, even if they are both in the same location. Three elements are involved in a handover: (1) handover condition (2) handover decision, and (3) handover execution. The handover condition is met if there is an end-user agent that can receive the data packets and is willing to receive the data packets that are would be handed over to it by the handover controller. Handover conditions in this invention are communicated to the handover controller by means of quality signals. Handover controllers are responsible for analyzing quality signals and making handover decisions. The handover execution transition should, ideally, be seamless and produce an uninterrupted service of acceptable quality. Handover execution may be carried out by handover controller and end-user agents. A handover controller commands a handover execution, and the packet data path is established between the end-user agents, either directly or through a handover controller if data packet re-encapsulation and processing such as decryption and encryption is required.

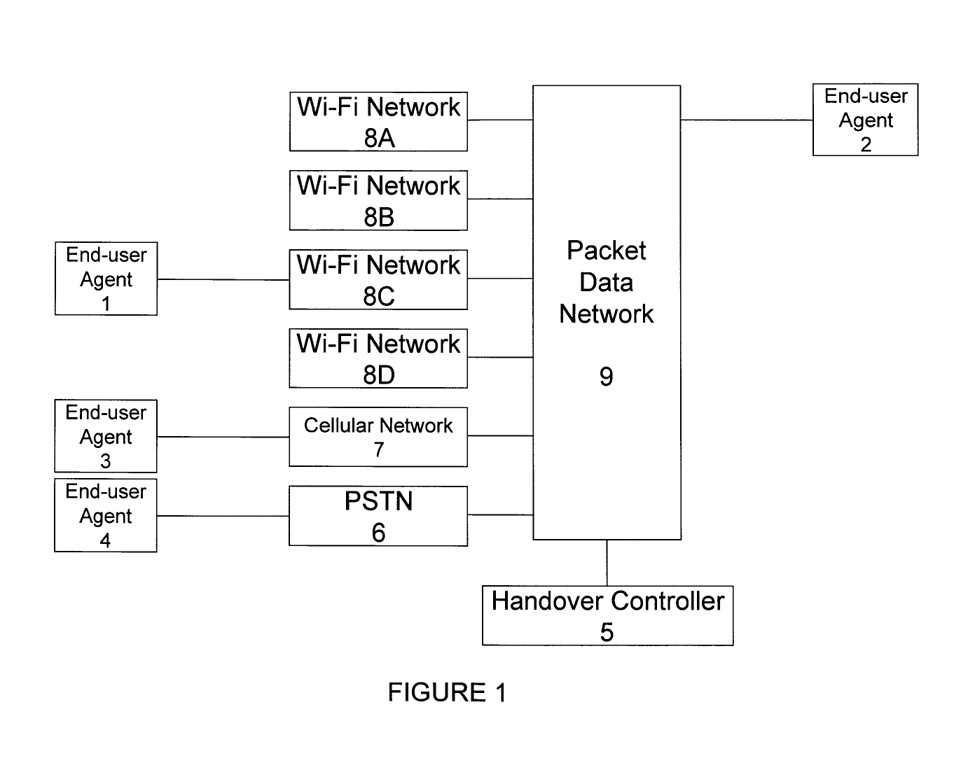

FIG. 1 is a block diagram of a handover controller system 5 in accordance with one embodiment of the present invention. Handover controller system 5 may comprise, for example, a public switched telephone network (PSTN) 6, a cellular network 7, one or more Wi-Fi networks 8a, 8b, 8c and 8d, one or more data networks 9, and two or more end-user agents 1, 2, 3, and 4. End-user agents 1, 2 and 3 may be registered with handover controller 5 through disparate communication networks, for example, Wi-Fi Network 8, Data Network 9, and Cellular Network 7, as shown in FIG. 1.

End-user agents such as 1, 2, and 3 attached to a packet data network may communicate quality signals to handover controller 5. End-user agent 3 may be connected through Data Network 9 with another end-user agent 4 that may be connected to Data Network 9, but not necessarily registered with handover controller 5.

As an example, a handover controller 5 may analyze the received quality signals and may decide to handover data packets, e.g., from end-user agent 3 to end-user agent 1. A handover controller 5 may initiate a handover process by notifying end-user agent 1 of the handover process by means of a session initiation command, through Data Network 9; receiving a session initiation acknowledge signal from the end-user agent 1, and by notifying end-user agent 3 of the handover by means of a session termination signal; and, for example, in a case in which data packets were initially being communicated between end-user agent 4 and end-user agent 3, by creating a data path between the end-user agent 4 and the end-user agent 1, and by terminating a data path between the end-user agent 4 and the end-user agent 3. Packet data path may be routed through a handover controller 5 for packet data processing such as decryption and encryption, aggregation and re-encapsulation; however, end-user agents 4 and 1 become electrically connected through Data Network 9 for bidirectional full duplex communication.

In the above exemplary scenario, the handover session initiation command is received by the end-user agent 1, and the end-user agent 1 responds to the handover command message by transmitting a session initiation acknowledge message to a handover controller 5. A data path may be created between end-user agent 4 and end-user agent 1, where a data path initiation command is received from a handover controller 5 by the target end-user agent 1, and the end-user agent responds to the handover command message by transmitting a data path acknowledge message to handover controller 5 and simply receiving and transmitting data packets through the data port that is physically connected to the Data Network 9. The data path termination command may be received from a handover controller 5 by the terminated end-user agent 3, and the end-user agent may respond to the handover command message by terminating a pre-existing data path and simply stopping reception and transmission of data packets through the data port that is physically connected to the Data Network 9.

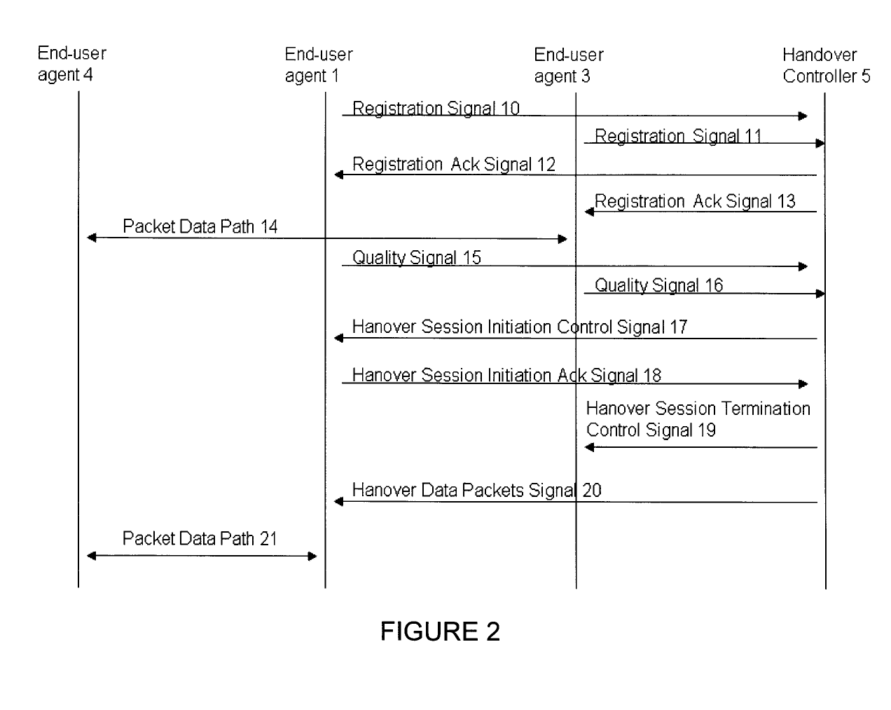

FIG. 2 is a chain of events control diagram, according to an exemplary embodiment of the invention, presenting the handover process from initiation to completion by way of the above example, in which communication initially occurs between end-user agents 3 and 4, and the communication with end-user agent 3 is to be handed over to end-user agent 1. Prior to a handover, end-user agent 4 and end-user agent 3 are connected through a data path 14. End-user agent 1 and end-user agent 3 register with handover controller 5 by means of registration signals 10 and 11, respectively. Handover controller 5 acknowledges registration by means of registration acknowledgment (“registration Ack”) signals 12 and 13, respectively. End-user agents 1 and 3 send quality signals 15 and 16, respectively, to the handover controller 5. A handover controller 5 decides to handover data packets from end-user 3 to end-user 1, and thus sends a handover session initiation control signal 17 to end-user agent 1. End-user agent 1 then acknowledges session initiation by means of handover session initiation Ack signal 18. The handover controller 5 sends a handover session termination control signal 19 to end-user agent 3. The handover controller 5 initiates a packet data path between end-user agent 4 and end-user agent 1 by means of handover data packets signal 20. A packet data path 21 is established between end-user agent 4 and end-user agent 1. The packet data path 14 between end-user 4 and end-user 3 is terminated.

A handover controller may analyze quality signals sent to them by end-user agents, as described in the exemplary embodiments above, and may compute end-user agents' availabilities to receive and transmit data packets. By way of example, if a quality signal represents a marginal signal strength or excessive jitter or packet drop, the handover controller could decide that the end-user agent is not available to receive packets, and may thus remove the end-user agent from the set of possible targets for handover operation. An end-user agent may be a software client that registers with at least one handover controller. By way of example, said end-user agent may comprise a software client embedded in a wireless handheld device or in a media gateway controller. Such a software client might have a configuration setting to determine the quality signal parameters, their type (such as Boolean/number/characters), size of field, sequence of fields transmission and/or other means to define the transmission protocol between the end-user agent and the handover controller. It is possible that end-user agents or software clients may register with at least one handover controller in response to a trigger from a handover controller or without receiving any trigger from a handover controller. During the registration process, an end-user agent may also transmit at least one quality signal to at least one handover controller. An end-user agent or a software client that transmits at least one quality signal to a handover controller could do so in response to a trigger from a handover controller or voluntarily, without such trigger, or in response to a change in at least one of the elements reflected in the quality signal. The quality signal may comprise an instantaneous signal strength record. A quality signal could further comprise a Boolean signal record such as available/not-available or good quality/unreliable quality or on/off A quality signal may also comprise a signal source location identification record. By way of example, a location identification record may contain three categories, such as home/office/mobile, in a numeric or character set format. A quality signal could further comprise one or more of the following: an average signal strength record, a signal power fluctuation duty cycle record, an average signal power record, a signal up-time time-stamp record, an uninterrupted accumulated signal up-time record, an instantaneous packet loss record, an average packet loss record, an instantaneous bandwidth record, an average bandwidth record, an instantaneous network latency record, an average network latency record, an interference signal record, an average interference signal record, and control information, such as session initiation or termination control signals. By way of further example, a session initiation signaling protocol, such as session initiation protocol (SIP) commands Invite or Bye, could be incorporated into a quality signal.

A quality signal could further comprise application specific information. Such information could comprise variables related to applications, such as video games, audio conferencing, web conferencing, or video conferencing. For each such application, the application specific control data may, for example, contain a sensitivity threshold for the quality signals. By way of example, a threshold for video signal handover may be different from a threshold for a voice signal handover.

A quality signal could be further processed by a handover controller so that the average signal strength is computed. Quality signal computation by a handover controller could further comprise signal power fluctuation duty cycle record computation, average signal power record computation, signal up-time time-stamp record computation, uninterrupted accumulated signal up-time record computation, average packet loss record computation, average bandwidth record computation, average network latency record computation, average signal congestion record computation, and/or average signal interference record computation. Such computed signal quality records could then be compared by a handover controller to a predefined set of rules or thresholds. Such rules may possibly change dynamically over time as a handover controller analyzes history data and adapts to it by smoothing it or filtering it in order to protect against bouncing, sometimes called debouncing, and noise riding thresholds.

The selection of at least one end-user agent to which to handover data packets may comprise the establishing of a data path between a one transmitting end-user agent and a receiving end-user agent. The analysis of the received quality signals and computing end-user agent availability to receiving and transmitting data packets may include reviewing history data records to determine if at least one end-user agent is available. The handing over of data packets received from one or more end-user agents to at least one other end-user agent may also include logging the handover operation details, such as time stamp and reason for handover. Selection of at least one end-user agent to which data packets should be handed over may also comprise selecting at least one end-user agent to discontinue a pre-existing data path with at least one end-user agent, and/or disconnecting a data path between at least one transmitting end-user agent and the at least one receiving end-user agent, and/or locking at least two end-user agents in preparation for handover. Such a mechanism is sometimes referred to as “make before brake.” Such locking in preparation for handover may include disconnecting at least one end-user agent prior to handover of data packets to at least another end-user agent and may be performed by the handover controller after verifying end-user agents' availability. Alternatively, the locking of end-user agents in preparation for handover may be performed by an individual end-user agent in response to a command from a handover controller sent after verifying end-user agents' availability by the handover controller. Establishing a data path between at least two end-user agents may also include re-encapsulating data into data packets for transmission between the selected end-user agents. Re-encapsulating data may include supplying signaling information about the destination of data packets and/or decrypting the contents of data packets and/or encrypting the contents of data packets.

An apparatus, according to various embodiments of the invention, may comprise means for receiving registration signals, such as a proxy server or registrar for access control, authentication and authorization. It may also include means for end-user agents to receive registration trigger signals from handover controllers. An end-user agent may comprise means for generating a quality signal and transmitting a quality signal to at least one handover controller. An apparatus according to various embodiments of the invention, may also comprise means for detecting a variation in at least one of the elements of a quality signal. By way of example, means for variation detection may comprise variable length windowing or data buffering and perturbation gap analysis within such windowing. One example of such a method may include collection of packet loss information over a two-second window and searching for a maximum period of no packet received within that window, and if the no-packet period crosses a threshold, it may be identified as an event for triggering a quality signal transmittal to handover controller. By way of example, an end-user agent may include means for measuring instantaneous wireless network signal strength and may also include means for encapsulating it into a quality signal. Wireless signals, however, might fluctuate significantly over time. Windowing and variation detection techniques may limit the amount of data sent from the end-user agent to a handover controller by smoothing the quality signal and possibly transmitting only an amplitude delta signal, first derivative, and/or, possibly, second derivative. An end-user agent may also comprise means for measuring, computing and encapsulating signal quality elements. If the end-user agent computation power is limited, raw data may be transmitted.

Distribution of quality signal analysis from the handover controller to the end-user agents may be beneficial in other cases, as noted above, in order to limit the overhead associated with quality signal transmission and the handover process. In those cases, end-user agents may comprise means for measuring, computing and encapsulating records, such as a moving average packet loss record and/or a moving average network latency record.

The apparatus according to some embodiments of the invention may further comprise means for measuring, computing and encapsulation of a signal source location identification record. Said source location identification may be, by way of example, an identification number or code or description of the originating device, such as a game console, a personal computer, mobile phone, office phone or home phone. The location information could be inferred by a handover controller based on predefined correlation tables, as may be created by users or system administrators, to a specific location such that a game console or home phone means location home and office phone means location office.

In some embodiments of the invention, the means for analyzing the received quality signals and computing end-user agents' availability to receiving and transmitting data packets may also include means for reviewing history data records to determine if the at least one end-user agent is available. Such history analysis could provide means to detect movement of end-user agents and migration patterns of end-users between/among devices. By way of example, when a handover controller detects a specific use pattern, such as a user departing from his/her office and becoming available at his/her cellular phone device every day at a certain time of day, a handover process can be triggered based on the understanding of the most probable availability in the office or on the mobile phone based on this analysis of historical data. Moreover, if history data shows that a handover was successfully executed to a specific end-user agent just recently or last time, the handover controller could give priority to handing over the next connection to the same end-user agent instead of to another one that is rarely being used. The handover controller and possibly end-user agents could further comprise means for logging the handover operation details in order to enable such history data analysis.

The apparatus according to some embodiments of the invention may further comprise means for selecting at least one end-user agent to discontinue a pre-existing data path with at least one end-user agent. The means for selecting at least one end-user agent from which to handover data packets may further comprise means for discontinuing a data path between at least one transmitting end-user agent and the at least one receiving end-user agent. Such apparatus may further comprise means for locking at least two end-user agents in preparation for handover, which may be embedded in a handover controller. The end-user agents may further comprise means for receiving and responding to a lock command made by handover controllers. The means for establishing a data path between at least two end-user agents may further comprise means for re-encapsulating data into data packets for transmission between the selected end-user agents. Such re-encapsulation could, by way of example, translate data from one signaling protocol to another signaling protocol or from one media control protocol to another media control protocol, or both. In certain cases the means for re-encapsulating data may further comprise means for encrypting the contents of data packets. The apparatus, in some embodiments of the invention, may further comprises means for supplying signaling information about the destination of data packets.

Certain embodiments of the present invention may provide a number of technical advantages. By way of example, according to one embodiment of the present invention, a handover execution may be provided that includes handover between an end-user agent 3, a cellular phone, and an end-user agent 1, an office voice over Wi-Fi packet data phone, that may otherwise be completely disintegrated or may otherwise take a significant effort in time and computation resources to seamlessly integrate and handover. By implementing a media over packet data (MoPD) handover controller, a handover controller 5 may minimize media handover latencies or avoid them, thereby increasing the overall quality of communications in a MoPD environment and making integration of disparate communications systems possible.

Various embodiments of the invention have been presented above. However, the invention is not intended to be limited to the specific embodiments presented, which have been presented for purposes of illustration. Rather, the invention extends to functional equivalents as would be within the scope of the appended claims. Those skilled in the art, having the benefit of the teachings of this specification, may make numerous modifications without departing from the scope and spirit of the invention in its various aspects.

What is claimed is:

1. A method for media data packet handover between networks selectively connecting end-user agents that are logically attached to at least one of the networks, the method comprising:
receiving, at one or more handover controllers, quality signals from two or more individual user agents attached to the packet data network;
analyzing the received quality signals and computing availabilities of the two or more end-user agents to receive and transmit data packets;
selecting at least one end-user agent to which to handover data packets; and
handing over data packets received from at least one end-user agent to at least one end-user agent.

2. The method as recited in claim 1, wherein at least one end-user agent comprises a software client to generate a quality signal and to transmit at least one quality signal to at least one handover controller.

3. The method as recited in claim 1, said selecting at least one end-user agent to which to handover data packets comprises:
establishing a data path between at least one transmitting end-user agent and at least one receiving end-user agent.

4. The method as recited in claim 1, wherein said analyzing the received quality signals and computing availabilities of the two or more end-user agents to receive and transmit data packets comprises:
reviewing history data records to determine if at least one end-user agent is available.

5. The method as recited in claim 1, wherein said handing over data packets received from at least one end-user agent to at least one end-user agent comprises logging at least one detail of the handover.

6. The method as recited in claim 1, wherein said selecting at least one end-user agent to which to handover data packets comprises:
selecting at least one end-user agent to discontinue a pre-existing data path with at least one end-user agent.

7. The method as recited in claim 1, wherein selecting at least one end-user agent to which to handover data packets comprises:
discontinuing a data path between at least one transmitting end-user agent and at least one receiving end-user agent.

8. The method as recited in claim 1, wherein selecting at least one end-user agent to which to handover data packets comprises:
locking at least two end-user agents in preparation for handover.

9. The method as recited in claim 8, wherein said locking at least two end-user agents in preparation for handover comprises:
disconnecting at least one end-user agent prior to handover of data packets to at least another end-user agent.

10. The method as recited in claim 8, wherein said locking at least two end-user agents in preparation for handover is performed by a handover controller after verifying end-user agents' availability.

11. An apparatus for media data packet handover between networks selectively connecting end-user agents that are logically attached to the networks, the apparatus comprising at least one handover controller, said at least one handover controller comprising:
means for receiving quality signals from individual end-user agents;
means for analyzing the received quality signals and computing availabilities of end-user agents to receive and transmit data packets;
means for selecting at least one end-user agent to which to handover data packets; and
means for handing over data packets received from at least one end-user agent to at least one end-user agent.

12. The apparatus as recited in claim 11, further comprising:
at least one end-user agent comprising means for generating a quality signal and transmitting at least one quality signal to at least one handover controller.

13. The apparatus as recited in claim 11, further comprising:
at least one end-user agent comprising means for measuring, computing and encapsulating signal quality elements into at least one quality signal.

14. The apparatus as recited in claim 11, further comprising:
at least one end-user agent to transmit a quality signal to a handover controller, the at least one end-user agent comprising means for detecting at least one variation in at least one element of the quality signal.

15. The apparatus as recited in claim 11, further comprising:
at least one end-user agent comprising a software client embedded in a wireless handheld device.

16. The apparatus as recited in claim 14, wherein said at least one end-user agent further comprises:
means for measuring instantaneous wireless network signal strength; and
means for encapsulating said instantaneous wireless network signal strength into at least one quality signal.

17. The apparatus as recited in claim 11, wherein the means for selecting at least one end-user agent to which to handover data packets further comprises:
means for selecting at least one end-user agent to discontinue a pre-existing data path with at least one end-user agent;
means for discontinuing a data path between at least one transmitting end-user agent and at least one receiving end-user agent; and
means for locking at least two end-user agents in preparation for handover.

18. The apparatus as recited in claim 11, wherein the means for establishing a data path between at least two end-user agents comprises:
means for re-encapsulating data into data packets for transmission between selected end-user agents; and
means for supplying signaling information about a destination of data packets.

19. A method for data packet handover from at least one end-user agent to at least one end-user agent that is logically attached to at least one handover controller, the method comprising:
measuring at least one packet communication signal parameter and encapsulating a record of said at least one packet communication signal parameter into at least one quality signal;
transmitting the at least one quality signal to at least one handover controller;
responding to at least one handover signal received from at least one handover controller; and
transmitting data packets to and receiving data packets from at least one end-user agent as directed by the at least one handover controller.

20. The method as recited in claim 19, wherein said measuring at least one packet communication signal parameter and encapsulating a record of said at least one packet communication signal parameter into at least one quality signal comprises:
transmitting a handover request to a handover controller.

21. An end-user agent apparatus for data packet handover from at least one other end-user agent to at least a second other end-user agent that is logically attached to at least one handover controller, the apparatus comprising:
means for measuring at least one packet communication signal parameter and encapsulating a record of said at least one packet communication signal parameter into at least one quality signal;
means for transmitting the at least one quality signal to at least one handover controller;
means for responding to at least one handover signal received from at least one handover controller; and
transmitting data packets to and receiving data packets from at least one end-user agent as directed by the at least one handover controller.

22. The apparatus as recited in claim 21, wherein the means for measuring at least one packet communication signal parameter and encapsulating a record of said at least one packet communication signal parameter into at least one quality signal further comprises means for transmitting a handover request to a handover controller.

23. The apparatus as recited in claim 21, wherein at least one end-user agent comprises a software client that is attached to at least one network selected from the group consisting of the following: an Internet Protocol network; a cellular network; a public switch telephone network (PSTN); and a packet data network.
